(19) United States
(12) Patent Application Publication
(10) Pub. No.: US 2026/0368820 A1
(43) Pub. Date: Nov. 19, 2026

(54) SYTEM FOR QUANTITATIVE CALCULATION OF ALIGNMENT OF PORTFOLIO WITH QUALITATIVE NON-FINANCIAL VALUES

(71) Applicant: Jason Britton, Mount Pleasant, SC (US)

(72) Inventors: Jason Britton, Mount Pleasant, SC (US); Howard W. Buffett, Omaha, NE (US)

(21) Appl. No.: 18/887,331

(22) Filed: Sep. 17, 2024

Related U.S. Application Data
(60) Provisional application No. 63/539,006, filed on Sep. 18, 2023.

(51) Int. Cl. G06Q 40/06

(52) U.S. Cl. CPC G06Q 40/062

(57) ABSTRACT

The system transforms qualitative metrics of a company's performance of SEE and an investor's SEE values into quantitative metrics that may be compared across companies, investors, and time. Moreover, by determining the match score, the investor is able to quantitatively assess how the investor's portfolio reflects their values. Finally, determining the match score allows the investor to track (e.g. logging information) and monitor (i.e. reviewing logged information) the alignment of their portfolio with their SEE values over time and across changing (i) investor SEE values, (ii) holdings in an investor's portfolio, and (iii) company SEE performance.

This application claims the benefit of U.S. Provisional Application No. 63/539,006 entitled “SYSTEM FOR QUANTITATIVE CALCULATION OF ALIGNMENT OF PORTFOLIO QITH QUALITATIVE NON-FINANCIAL VALUES” filed Sep. 18, 2023, which is incorporated by reference in its entirety.

### BACKGROUND

With a growing societal focus on non-financial values and stakeholder engagement, challenges associated with these non-financial values facing society, as well as measurement of SEE through a variety of mechanisms, companies and investors are placing a growing focus on SEE performance. One way in which this SEE focus manifests is through evaluating alignment of a company's SEE performance with an investor's individual values. A company's SEE performance by its nature has subjective components, and an individual investor's values related to importance of particular categories of SEE performance are subjective. A need exists to evaluate how an investor's portfolio aligns with and reflects their SEE values on a quantitative basis to measure SEE performance between companies and across time.

Conventional methods for determining how well an investor's portfolio aligns with and reflects an investor's values include subjective assessment. Subject assessment includes an investor or advisor assessing a general sense of the investor's values as represented by SEE performance and evaluating a company's SEE performance. Evaluation of a company's SEE performance may include subjectively assessing data that a company publishes on one or more categories of its SEE performance. From here, an investor or advisor subjectively assesses how well the company aligns with the investor's SEE values. Subjective assessment does not include an objective measurement for comparison of companies, nor evaluation of performance over time.

Conventional methods also include objective assessment of SEE performance of companies (e.g. Your Stake) with subjective evaluation by investors. These objective assessment methods evaluate the performance of companies against SEE values to provide a static score that is used by investor's to determine the alignment of a company with their own SEE values. Thus, objective assessment with subjective evaluation does not provide an objective assessment of how well a company's SEE performs against an investor's own SEE values.

Other conventional methods for determining non-financial values of a company that inventors utilize include evaluation of a company's SEE risks that impact profitability (e.g. SASB Standards). Risk-based SEE assessment utilizes data for objective comparison, while providing a focus on SEE issues that will affect profitability of a company. Investors may utilize this risk-based evaluation to influence investing decisions. Thus risk-based assessment does not provide an objective measurement of how the investor's own non-financial values are reflected by a company.

Therefore it is desirable for a system to quantitatively and dynamically represent an investor's values and assess quantitative determinations of a company's SEE performance against those values. It is further desirable for a system to determine the quantitative dollar weighted alignment of an investor's portfolio against the investor's SEE values. Finally, it is desirable for the system to determine the quantitative dollar weight alignment of an investor's portfolio against the investor's SEE values over time and across changing (i) SEE values, (ii) holdings in an investor's portfolio, and (iii) company SEE performance.

### SUMMARY

In aspects, A method for quantitatively calculating the alignment of an investor's non-financial values against a portfolio via a computer network, the method including receiving a reflect score calculation input at a first computer system, the reflect score calculation input having been transmitted via the computer network from a second computer system, the reflect score calculation input comprising a request to being calculation of a match score, the first computer system being associated with a service provider, the second computer system being associated with the investor; transmitting a holdings selection output from the first computer system to the second computer system via the computer network, the holdings selection output configured for causing the holdings selection to be provided to the second computer system, wherein providing the holdings selection includes causing a webpage having holdings selections to be displayed via a display of the second computer system, the webpage being associate with a website of the service provider; receiving a holdings input at the first computer system, the holdings input having been transmitted from the second computer system to the first computer system via the computer network, the holdings input comprising holdings of the portfolio and configured for storing the holdings by the first computer system; processing category corporate scores, the processing configured to assign the category corporate scores to the holdings and to store the category corporate scores in association with the holdings, respectively; transmitting a lens selection output to the second computer system via the computer network, the lens selection output configured for causing a lens selection to be provided to the second computer system, wherein providing the lens selection includes causing the webpage having lens selections to be displayed via the display of the second computer system; receiving a lens selection input at the first computer system, the lens selection input having been transmitted from the second computer system to the first computer system via the computer network, the lens selection input comprising the investor's non-financial values and configured for storing the lens selection by the first computer system; based upon the lens selection input, processing the lens selection input, the lens selection input being processed by the first computer system, the processing of the lens selection input configured to assign category ratings and category numerical ratings in association with the categories, respectively, for determination of a weighting variable, wherein the weighting variable is determined by a weighting variable algorithm of 100/((Numerical rating of EI*Number of assigned EI category ratings)+(Numerical rating of VI*Number of assigned VI category ratings)+(Numerical rating of I*Number of assigned I category ratings) based upon the weighting variable, processing category weights for determination of a match score, the processing of the category weights configured to assign category weights, wherein the category weights are determined by multiplying the category numerical rating and the weighting variable and configured to store the category weights; based upon the stored category corporate score and category weights, processing a user-adjusted composite corporate score for each holding, the processing of the user-adjusted composite corporate score for each holding configured for assigning each holding its user-adjusted composite corporate score and for storing each user-adjusted composite corporate score in association with the holding, respectively; based upon the user-adjusted composite corporate score, processing the match score, the processing of the match score configured to assign a reflect scale to each holding, wherein the match score is the percentage of the currency of the holdings having an aligned reflect scale out of the currency of the portfolio and configured for storing the match score; based upon the stored match score, transmitting a match score output to the second computer system via the computer network, the match score output configured for causing the stored match score to be provided to the second computer system, wherein providing the stored match score includes causing the webpage having the stored match score to be displayed via the display of the second computer system.

The method of paragraph [0006] further including, based upon the lens selection output, receiving a pre-refined lens selection input at the first computer system, the pre-refined lens selection input having been transmitted from the second computer system to the first computer system via the computer network, the pre-refined lens selection input comprising the predetermined lens selection and configured for storing the predetermined lens selection by the first computer system; based upon the pre-refined lens selection input, transmitting a lens refinement selection output from the first computer system to the second computer system via the computer network, the lens refinement selection output configured for causing the lens refinement to be provided to the second computer system, wherein providing the lens refinement selection includes causing a webpage having categories displayed in association with modifiable ratings to be displayed via a display of the second computer system; and wherein the lens selection input further comprises the refined lens selection.

The method of paragraph [0006] further including transmitting an issues selection output from the first computer system to the second computer system via the computer network, the issues selection output configured for causing the issues selection to be provided to the second computer system, wherein providing the issues selection includes causing a webpage having issues displayed for selection via a display of the second computer system; receiving an issues selection input at the first computer system, the issues selection input having been transmitted from the second computer system via the computer network, the issues selection input comprising issues and configured for storing the issues by the first computer system, wherein processing the match score further comprises identifying holdings that are associated with the stored issues, and wherein the match score output is further configured to display the identified holdings and the corresponding stored issues.

In aspects, A method for quantitatively calculating the alignment of an investor's non-financial values against a portfolio via a computer network, the method including receiving a reflect score calculation input at a first computer system, the reflect score calculation input having been transmitted via the computer network from a second computer system, the reflect score calculation input comprising a request to being calculation of a match score, the first computer system being associated with a service provider, the second computer system being associated with the investor; transmitting a holdings selection output from the first computer system to the second computer system via the computer network, the holdings selection output configured for causing the holdings selection to be provided to the second computer system, wherein providing the holdings selection includes causing a webpage having holdings selections to be displayed via a display of the second computer system, the webpage being associate with a website of the service provider; receiving a holdings input at the first computer system, the holdings input having been transmitted from the second computer system to the first computer system via the computer network, the holdings input comprising holdings of the portfolio and configured for storing the holdings by the first computer system; processing category corporate scores, the processing configured to assign the category corporate scores to the holdings and to store the category corporate scores in association with the holdings, respectively; transmitting a lens selection output to the second computer system via the computer network, the lens selection output configured for causing a lens selection to be provided to the second computer system, wherein providing the lens selection includes causing the webpage having lens selections to be displayed via the display of the second computer system; receiving a lens selection input at the first computer system, the lens selection input having been transmitted from the second computer system to the first computer system via the computer network, the lens selection input comprising the investor's non-financial values and configured for storing the lens selection by the first computer system; based upon the lens selection input, processing the lens selection input, the lens selection input being processed by the first computer system, the processing of the lens selection input configured to assign category ratings and category numerical ratings in association with the categories, respectively, for determination of a weighting variable, wherein the weighting variable is determined by a weighting variable algorithm of 100/((Numerical rating of EI*Number of assigned EI category ratings)+(Numerical rating of VI*Number of assigned VI category ratings)+(Numerical rating of I*Number of assigned I category ratings) based upon the weighting variable processing category weights for determination of a composite match score, the processing of the category weights configured to assign category weights, wherein the category weights are determined by multiplying the category numerical rating and the weighting variable and configured to store the category weights; based upon the stored category corporate score and category weights, processing a user-adjusted composite corporate score for each holding, the processing of the user-adjusted composite corporate score for each holding configured for assigning each holding its user-adjusted composite corporate score and for storing each user-adjusted composite corporate score in association with the holding, respectively; based upon the user-adjusted composite corporate score, processing the composite match score, the processing of the composite match score configured to assign a reflect scale to the portfolio, wherein the composite match score is the summation of the product of a dollar weight of the holding multiplied by the user-adjusted composite corporate score of the holding and configured to store the composite match score; based upon the stored composite match score, transmitting a composite match score output to the second computer system via the computer network, the composite match score output configured for causing the stored composite match score to be provided to the second computer system, wherein providing the stored composite match score includes causing the webpage having the stored composite match score to be displayed via the display of the second computer system.

The method of paragraph [0009] further including based upon the lens selection output, receiving a pre-refined lens selection input at the first computer system, the pre-refined lens selection input having been transmitted from the second computer system to the first computer system via the computer network, the pre-refined lens selection input comprising the predetermined lens selection and configured for storing the predetermined lens selection by the first computer system; based upon the pre-refined lens selection input, transmitting a lens refinement selection output from the first computer system to the second computer system via the computer network, the lens refinement selection output configured for causing the lens refinement to be provided to the second computer system, wherein providing the lens refinement selection includes causing a webpage having categories displayed in association with modifiable ratings to be displayed via a display of the second computer system; and wherein the lens selection input further comprises the refined lens selection.

The method of paragraph [0009] further including transmitting an issues selection output from the first computer system to the second computer system via the computer network, the issues selection output configured for causing the issues selection to be provided to the second computer system, wherein providing the issues selection includes causing a webpage having issues displayed for selection via a display of the second computer system; receiving an issues selection input at the first computer system, the issues selection input having been transmitted from the second computer system via the computer network, the issues selection input comprising issues and configured for storing the issues by the first computer system, wherein processing the match score further comprises identifying holdings that are associated with the stored issues, and wherein the composite match score output is further configured to display the identified holdings and the corresponding stored issues.

The method of paragraph [0009] wherein the composite match score output is further configured to display the dollar weight of the holdings by holding class.

The method of paragraph [0009] wherein the composite match score output is further configured to display the dollar weight of the holdings by the portfolio.

The method of paragraph [0009] wherein the composite match score output is further configured to display the composite match score for each reflect scale value per pillar.

In aspects, a method for quantitatively calculating the alignment of an investor's non-financial values against a portfolio via a computer network, the method including receiving a reflect score calculation input at a first computer system, the reflect score calculation input having been transmitted via the computer network from a second computer system, the reflect score calculation input comprising a request to being calculation of a match score, the first computer system being associated with a service provider, the second computer system being associated with the investor; transmitting a holdings selection output from the first computer system to the second computer system via the computer network, the holdings selection output configured for causing the holdings selection to be provided to the second computer system, wherein providing the holdings selection includes causing a webpage having holdings selections to be displayed via a display of the second computer system, the webpage being associate with a website of the service provider; receiving a holdings input at the first computer system, the holdings input having been transmitted from the second computer system to the first computer system via the computer network, the holdings input comprising holdings of the portfolio and configured for storing the holdings by the first computer system; processing category corporate scores and pillar corporate scores, the processing configured to assign the category corporate scores and the pillar corporate scores to the holdings and to store the category corporate scores and the pillar corporate scores in association with the holdings, respectively; transmitting a lens selection output to the second computer system via the computer network, the lens selection output configured for causing a lens selection to be provided to the second computer system, wherein providing the lens selection includes causing the webpage having lens selections to be displayed via the display of the second computer system; receiving a lens selection input at the first computer system, the lens selection input having been transmitted from the second computer system to the first computer system via the computer network, the lens selection input comprising the investor's non-financial values and configured for storing the lens selection by the first computer system; based upon the lens selection input, processing the lens selection input, the lens selection input being processed by the first computer system, the processing of the lens selection input configured to assign category ratings and category numerical ratings in association with the categories, respectively, for determination of a weighting variable, wherein the weighting variable is determined by a weighting variable algorithm of 100/((Numerical rating of EI*Number of assigned EI category ratings)+(Numerical rating of VI*Number of assigned VI category ratings)+(Numerical rating of I*Number of assigned I category ratings) based upon the weighting variable processing category weights for determination of a pillar match score, the processing of the category weights configured to assign category weights, wherein the category weights are determined by multiplying the category numerical rating and the weighting variable and configured to store the category weights; based upon the stored category corporate score and category weights, processing user-adjusted pillar corporate score for each holding, the processing of the user-adjusted pillar corporate score for each holding configured for assigning each holding its user-adjusted pillar corporate score and for storing each user-adjusted pillar corporate score in association with the holding, respectively; based upon the user-adjusted pillar corporate score, processing the pillar match scores, the processing of the pillar match score configured to assign a reflect scale to each pillar, wherein the pillar match score is the summation of the product of a dollar weight of the holding multiplied by the user-adjusted pillar corporate score of the holding and configured to store the pillar match scores; based upon the stored pillar match scores, transmitting a pillar match score output to the second computer system via the computer network, the pillar match score output configured for causing the stored pillar match scores to be provided to the second computer system, wherein providing the stored pillar match scores includes causing the webpage having the stored pillar match scores to be displayed via the display of the second computer system.

The method of paragraph [0015] further including based upon the lens selection output, receiving a pre-refined lens selection input at the first computer system, the pre-refined lens selection input having been transmitted from the second computer system to the first computer system via the computer network, the pre-refined lens selection input comprising the predetermined lens selection and configured for storing the predetermined lens selection by the first computer system; based upon the pre-refined lens selection input, transmitting a lens refinement selection output from the first computer system to the second computer system via the computer network, the lens refinement selection output configured for causing the lens refinement to be provided to the second computer system, wherein providing the lens refinement selection includes causing a webpage having categories displayed in association with modifiable ratings to be displayed via a display of the second computer system; and wherein the lens selection input further comprises the refined lens selection.

The method of paragraph [0015] further including transmitting an issues selection output from the first computer system to the second computer system via the computer network, the issues selection output configured for causing the issues selection to be provided to the second computer system, wherein providing the issues selection includes causing a webpage having issues displayed for selection via a display of the second computer system; receiving an issues selection input at the first computer system, the issues selection input having been transmitted from the second computer system via the computer network, the issues selection input comprising issues and configured for storing the issues by the first computer system, wherein processing the pillar match score further comprises identifying holdings that are associated with the stored issues, and wherein the pillar match score output is further configured to display the identified holdings and the corresponding stored issues.

The method of paragraph [0015] wherein the pillar match score output is further configured to display the dollar weight of the holdings by holding class.

The method of paragraph [0015] wherein the pillar match score output is further configured to display the dollar weight of the holdings by the portfolio.

The method of paragraph [0015] wherein the pillar match score output is further configured to display the user-adjusted pillar corporate score per pillar as expressed by the reflect scale.

The method of paragraph [0015] wherein the pillar match score output is further configured to display the pillar match score for each reflect scale value per pillar.

### BRIEF DESCRIPTION OF FIGURES

FIG. 1 is a flow chart representing a method 100 for determining the match score.

FIG. 2 is a block diagram 200 representing a system for implementing the method shown in FIGS. 1, 4, and 5.

FIG. 3a is a representation of a display of a match score calculation input.

FIG. 3b is a representation of a display of a holdings input.

FIGS. 3c and 3d are representations of displays of a lens selection output.

FIG. 3e is a representation of a display of a match score.

FIG. 3f is a representation of a display of an issue selection output.

FIG. 3g is a representation of a display of composite match score in graphical format.

FIGS. 3h, 3i, and 3j are representations of pillar match scores in graphical format.

FIG. 3k is a representation of a display of a user-adjusted pillar corporate score of a holding as expressed by the reflect scale.

FIG. 3l is a representation of a display of a dollar weight of a holding per holding class.

FIG. 3m is a representation of a display of a flagged holdings listing.

FIG. 4 is a flow chart representing a method for determining the composite match score.

FIG. 5 is a flow chart representing a second method of processing a match score.

FIG. 6 is a flow chart representing a method of processing a match score that includes lens refinement.

### DETAILED DESCRIPTION

“Match score” means the quantitative dollar weighted value of the alignment of an investor's portfolio or a holding class against a selected lens represented as a percentage.

“Composite match score” means the quantitative dollar weighted value of the alignment of an investor's portfolio or a holding class against a selected lens represented on a reflect scale.

“Non-financial value” means consideration of factors that are not monetary, such as environmental, ethos (e.g. social), and stakeholder engagement (e.g. governance) considerations. Stakeholder engagement, environment, and ethos considerations may be referred to as SEE.

“Rating” means a qualitative value of important (I), very important (VI), or extremely important (EI).

“Pillar” means one of the SEE considerations.

“Category” means a value-based goal within a pillar. Categories within the environmental pillar include, Energy Use, Water Use, Emissions, Compliance, Packaging, Environmental Policies. Categories within the ethos pillar include Gender Equality, Diversity, Product Safety, Employee Benefits, Human Rights, Business Ethics. Categories within the stakeholder engagement pillar include Independent Directors, Chair/CEO Separation, Independent Compensation Audit, Executive Compensation Controls, Shareholder Voting Rights, SEE-Linked Compensation.

“Category rating” means the rating assigned to each category within a pillar.

“Category weight” means the weighted value of each category within a pillar. For predetermined lenses the category weight is stored in the first computer system according to the method 100. Category weights are calculated according to the following algorithm:

(category numerical rating*weighting variable)

“Corporate score” means the unadjusted SEE value assigned to a holding that may be on a per category, per pillar, or composite basis. The SEE value ranges on the scale from 0-4, and is a quantitative reflection of a holding's SEE performance based on its normative performance amongst other holdings, such as, for example normative performance amongst the holding's Global Industry Classification Standard (GICS®) peer group.

“Category corporate score” means the unadjusted corporate score assigned to a holding per category.

“Pillar corporate score” means the unadjusted SEE value assigned to a holding per pillar. The pillar corporate score is the average of the category corporate scores within a pillar.

“User-adjusted pillar corporate score” means the pillar corporate score that is adjusted to quantitatively reflect the user's values per holding. The user-adjusted pillar corporate score is determined according to the following algorithm:

sum of(category weight*category corporate score)for all categories within a pillar.

“User-adjusted composite corporate score” means the composite of all of the category corporate scores that is adjusted to quantitatively reflect the user's values per holding. The composite user-adjusted corporate score is determined according to the following algorithm:

(corporate pillar score for Environmental pillar*Environmental pillar weight)+(corporate pillar score for Ethos pillar*Ethos engagement pillar weight)+(corporate pillar score for Stakeholder engagement pillar*Stakeholder engagement pillar weight)=User-adjusted composite corporate score per holding or

sum of(category weight*category corporate score)for all categories=user-adjusted composite corporate score per holding.

“Weighting variable” is a dynamic, numeric variable that allows relative weighting of categories on a scale of 100 based on the category rating assigned by the user. The weighting variable is calculated according to the following algorithm, where “x” is the weighting variable:

x=100/((Numerical rating of EI*Number of assigned EI category ratings)+(Numerical rating of VI*Number of assigned VI category ratings)+(Numerical rating of I*Number of assigned I category ratings).

“Reflect scale” is a determination of alignment (i.e. not aligned, somewhat aligned, mostly aligned, highly aligned) of a holding against the lens. The alignment of a holding against the lens may be determined according to the corporate score, the user-adjusted pillar corporate score, or the user-adjusted composite corporate score as determined on a quartile basis.

“Numerical rating” means the numerical value assigned to a rating. For example, a rating of important is assigned a numerical value of 1, a rating of very important is assigned a numerical value of 2, and a rating of extremely important is assigned a numerical value of 4.

“Pillar rating” means the rating assigned to a pillar. The pillar rating may be assigned based on a predetermined lens selection. Alternatively, the pillar rating may be determined by processing of the customized ratings assigned to each category within a pillar. For a customized pillar rating, the system processes the pillar rating according to the following algorithm for each pillar and each category rating type:

category numerical rating*number of category ratings per rating type=points per category rating type
the category rating with the greatest number of points is the assigned pillar rating, where in the event that two category rating types have the same point value, then the pillar is assigned based on the category rating with the greatest frequency of selection.

“Pillar weight” means the weighted value assigned to a pillar. The system determines the pillar weight according to the category weights. The pillar weight is calculated according to the following algorithm:

summation of the category weights per pillar.

“Dollar weight” means the representative amount (percentage) that a holding has within a holding class or a portfolio. The dollar weight is determined by dividing the value in currency of the holding by the value in currency of the holding class or portfolio, for the dollar weight of the holding class and the dollar weight of the portfolio, respectively.

“Lens” means the qualitative set of values against which a portfolio is assessed.

“Portfolio” means the totality of investments.

“Holding class” means the types of investments in a portfolio. For example, holding classes include stocks, bonds, and equity investments.

“Holding” means an individual investment within a holding class.

By assessing the match score, the system transforms qualitative metrics into metrics that may be compared across companies, investors, and time. Moreover, by determining the match score, the investor is able to quantitatively assess how the investor's portfolio reflects their values. Finally, determining the match score allows the investor to track (e.g. logging information) and monitor (i.e. reviewing logged information) the alignment of their portfolio with their SEE values over time and across changing (i) investor SEE values, (ii) holdings in an investor's portfolio, and (iii) company SEE performance.

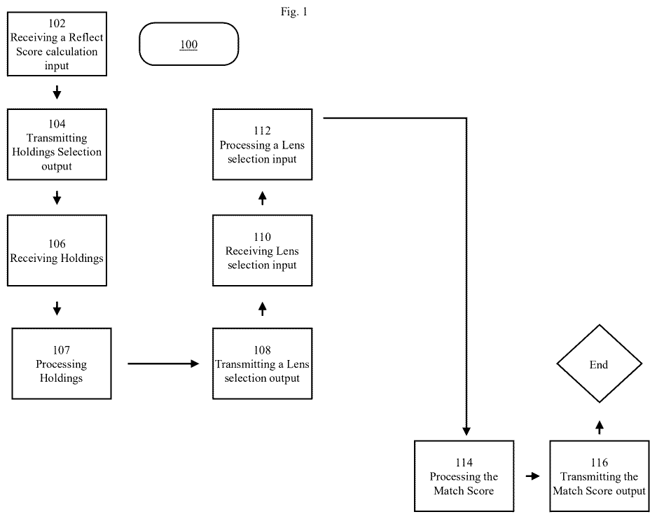

FIG. 1 represents a method 100 used by the system to determine the match score.

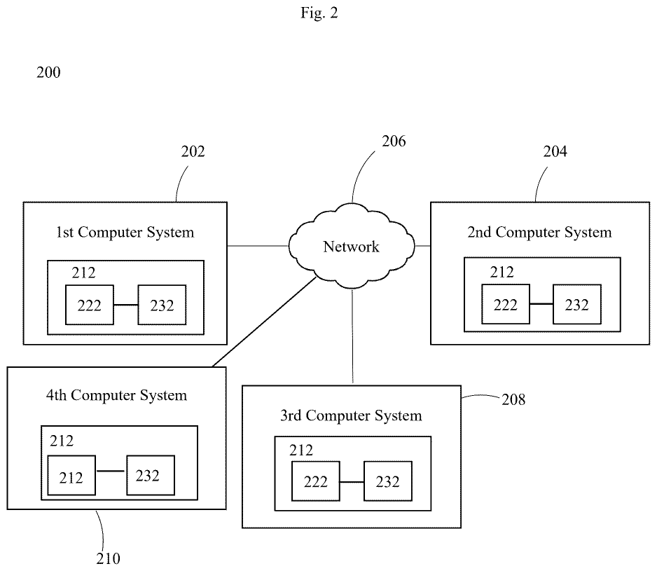

FIG. 2 is a block diagram of a system for implementing the methods of determining the match score. The system 200 may include a first computer system 202, a second computer system 204, a third computer system 208, and a fourth computer system 210. The calculation of the match score may be provided as computer-based (e.g. online, web-based) services via an Internet site (e.g. website) associated with a provider of the services (e.g. service provider). A first computer system 202 is associated with the service provider. The first computer system 202 may include one or more computing devices 212 (e.g. servers, nodes, computers). As used herein, the “computing device” may refer to a general purpose device that can be programmed to carry out various sets of arithmetic or logical operations. Further, the computing device may include one or more processing elements 222 (e.g. processors, central processing unit (CPU)) and some form of memory 232 (e.g. data storage device, database), the memory being connected to (e.g. communicatively coupled with) the processing element(s). The computing device may further include one or more user interface devices (e.g. user input devices), such as a keyboard, mouse, display, and/or the like, which are connected to (e.g. communicatively coupled with) the processing element(s). As used herein, the term “server” may refer to software (and suitable computer hardware) which is configured for providing (or helping to provide) a network service. For example, the term “server” may refer to software which is executed on a dedicated computer (e.g. hosted by a networked computer) or executed on a computer in a shared hosting environment. Further, the term “server” may refer to the dedicated computer itself. Further, the term “server” may refer to a computer program which may execute to service the requests of other computer programs. In embodiments in which the first computer system 202 includes multiple computing devices, the multiple computing devices of the first computer system may be connected to (e.g. communicatively coupled with) each other, including through application program interfaces (APIs).

A second computer system 204 is associated with an investing entity (e.g. individual investor, financial advisor, company, or the like) that desires to determine a match score. Such analysis may be conducted at any point during an investing lifecycle, as the match score will change as the dollar amounts per holding fluctuate, as SEE performance fluctuates, or as investor values change. While a particular time frame may be referenced herein, it is for example purposes only and is not limiting as to the timing of analysis of any activity.

The second computer system 204 may include one or more computing devices (e.g. servers, nodes, computers). The second computer system 204 may include multiple computing devices, the multiple computing devices of the second computer system 204 may be connected to (e.g. communicatively coupled with) each other. In examples, the second computer system 204 is remotely located from the first computer system 202.

The system may include a third computer system 208 that is associated with a third party providing data repository or reporting services on publicly traded or privately held companies, non-profits, political subdivisions, governmental entities, and the like that are accessible to the public or on a subscription basis. For example, the third party may be the Securities and Exchange Commission (“SEC”) that provides the Electronic Data Gathering, Analysis, and Retrieval (“EDGAR”) computer system, including the repository of Form N-PORT data files. The N-PORT data files include a variety of metrics that are processed by a fourth computer system 210 to normatively score a holding within each SEE category. The third party has relevant information and data for inclusion into the calculation of the match score.

The third computer system 208 may include one or more computing devices (e.g. servers, nodes, computers). The third computer system 208 may include multiple computing devices, the multiple computing devices of the third computer system 208 may be connected to (e.g. communicatively coupled with) each other. For example, the third computer system 208 is remotely located from the first computer system 202 and fourth computer system 210 and connected to the first computer system 202 and fourth computer system 204 via API calls.

The system may include the fourth computer system 210, where the fourth computer system 210 is associated with the service provider. The fourth computer system 210 may include one or more computing devices (e.g. servers, nodes, computers). The fourth computer system 210 may include multiple computing devices, the multiple computing devices of the fourth computer system 210 may be connected to (e.g. communicatively coupled with) each other. In examples, the fourth computer system 210 is remotely located from the first computer system 202 and the third computer system 206.

The fourth computer system 210 processes the corporate score for all holdings. The fourth computer system 210 receives data points (e.g. N-PORT files) from one or more third computer system(s) 206 via API calls or other electronic transfer mechanism. The fourth computer system 210 processes the data points (e.g. N-PORT files) to normatively score each company or fund within each SEE category to produce a corporate score per category, a pillar corporate score, and a composite corporate score. The corporate score ranges from 0-4, where a higher score indicates a more positive presentation of an SEE value. The fourth computer system 210 stores the corporate scores, and the first computer system 202 periodically receives the updated corporate scores, such as via API or other electronic data transfer.

The fourth computer system 210 may also determine when a holding is associated with an issue (e.g. alcohol, weapons, tobacco, gambling, pornography, animal testing, fossil fuels). A holding is associated with an issue if the company or fund underlying the holding benefits from the issue through commercialization. For example, companies would be associating with alcohol, weapons, or tobacco if they manufacture or distribute any of these items or animal testing if the products that the company sells are tested on animals. The fourth computer system determines issues associated with a holding by processing the data points received from the one or more third computer system(s) to determine whether the holding is associated with an issue. For example, the fourth computer system 210 may associate an issue with a holding if the holding is in a GICS industry associated with the issue or if the data points show the presence of one or more issues. The fourth computer system 210 the holdings associated with their respective issues (i.e. holdings—issues list), and the first computer system 202 periodically receives the updated holdings associated with their respective issues, such as via API or other electronic data transfer.

A user of the second computer system 204, such as an individual investor or financial advisor, may utilize the second computer system 204 to access the website associated with the service provider. Further, a web page of the website including a match score calculation request (e.g. icon, link, menu selection) may be displayed via a display of the second computer system 204. The user of the second computer system 204 may then provide an input which selects the match score calculation request, thereby causing the match score calculation request (i.e. the match score calculation input) to be transmitted to the first computer system 202 over the network 206.

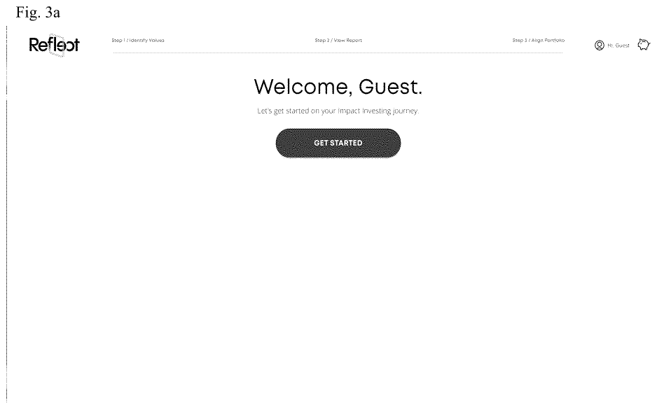

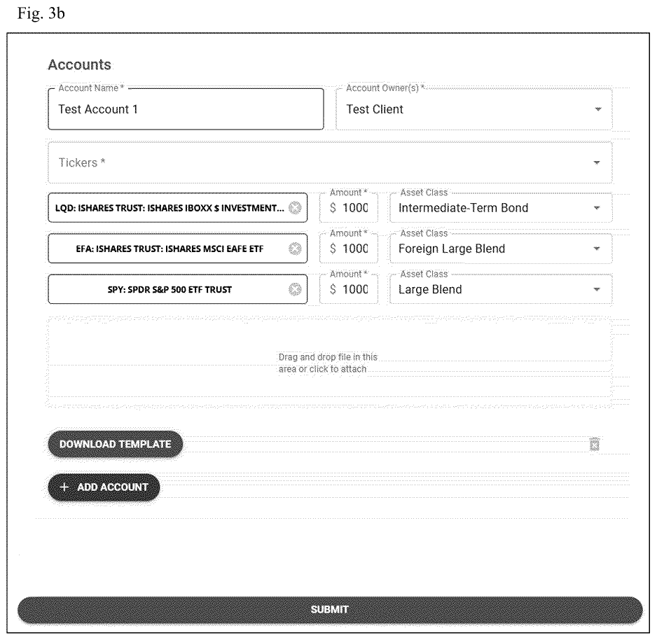

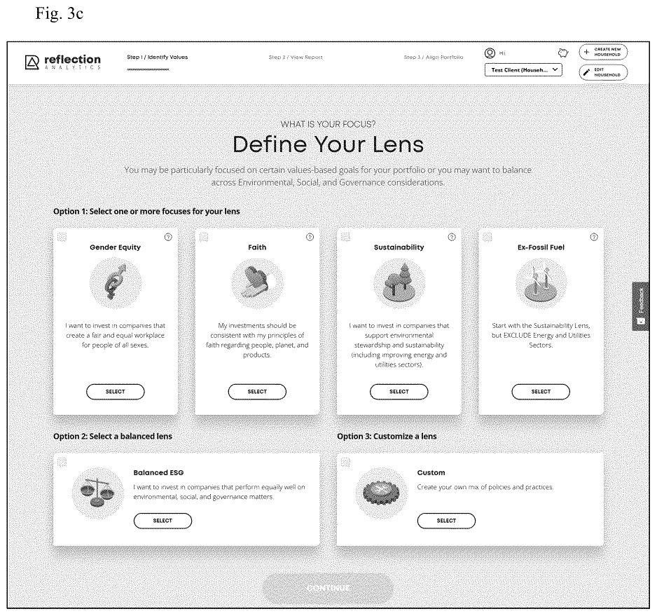

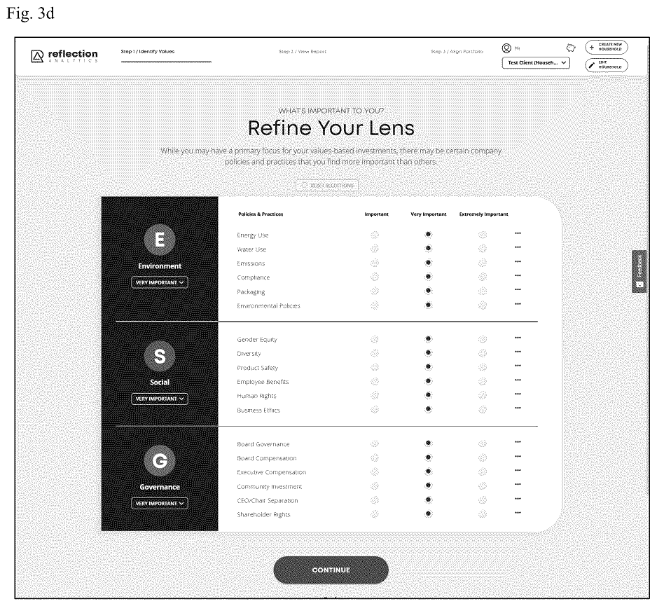

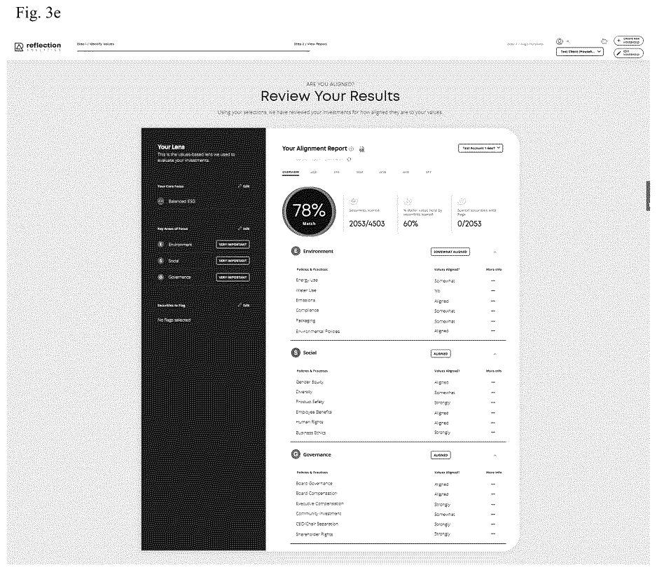

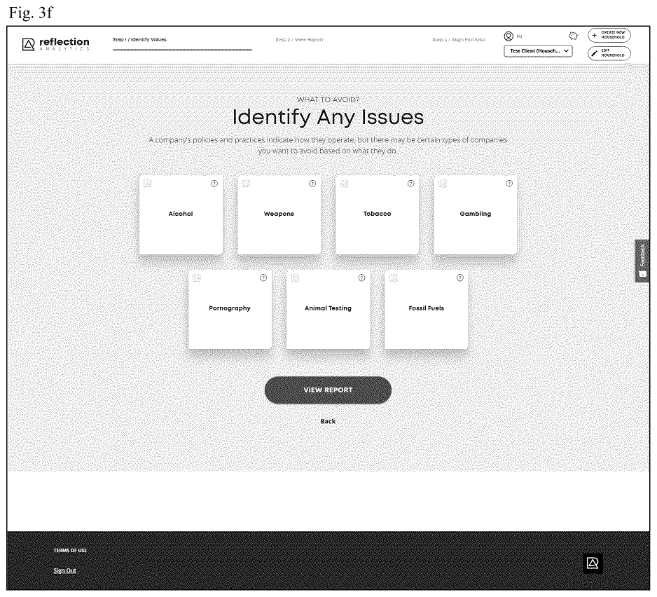

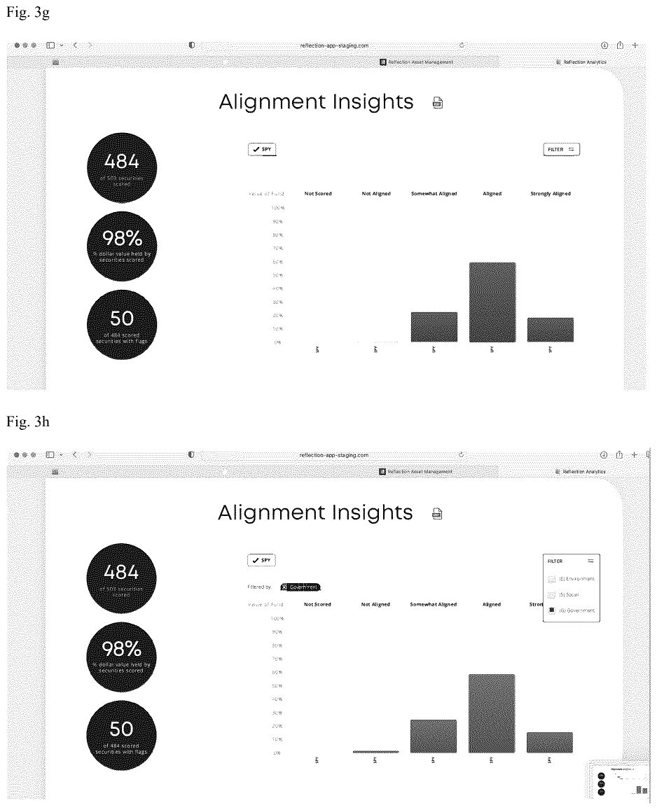

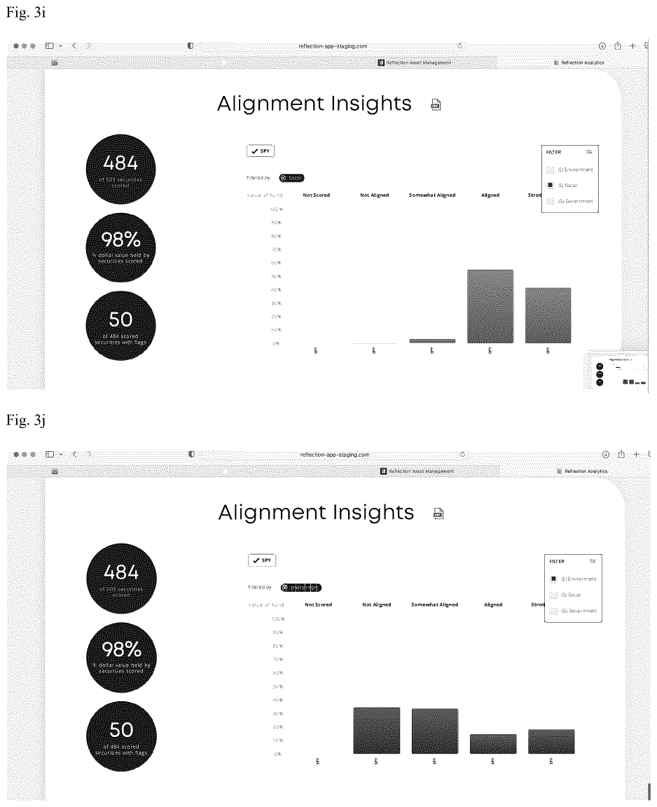

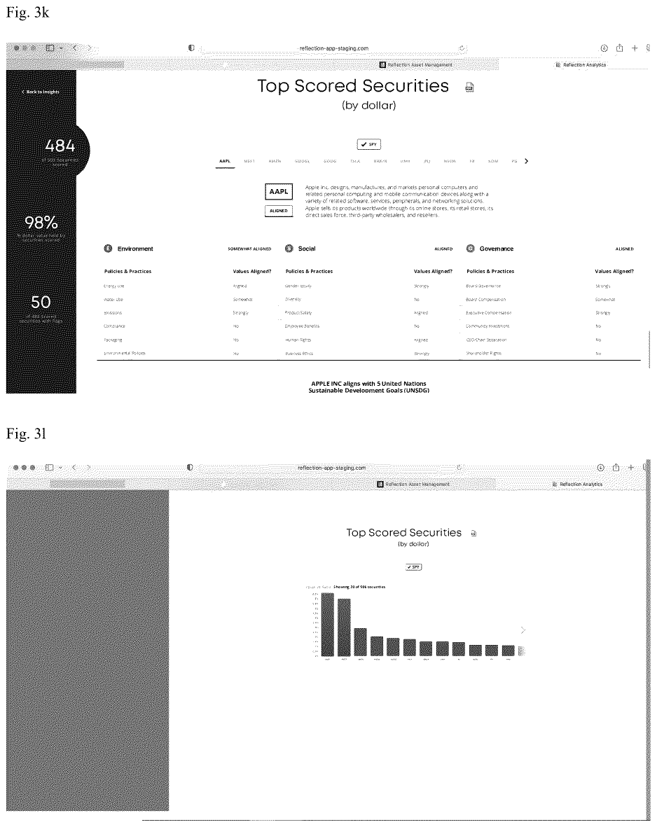

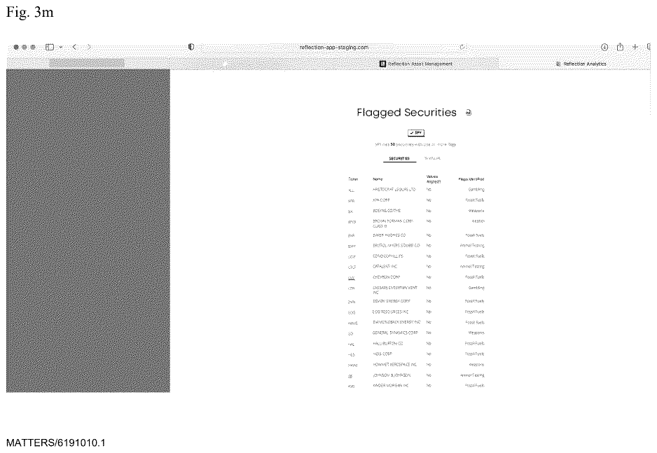

In 102, a first computer system 202 receives a match score calculation input, as represented in FIG. 3a. The match score calculation input having been transmitted via a computer network 206 from a second computer system 204. The match score calculation input includes a request to begin calculation of the match score.

In 104, based on the match score calculation input, transmitting a holdings selection output from the first computer system 202 to the second computer system 204 via the network 206. The holdings selection output is configured for causing the holdings selections to be provided to the second computer system 204. The holdings selection output is further configured to display holdings selections, such as on a webpage via drop down menu, free text search, scrolling menu, file upload or the like.

In 106, receiving a holdings input, the holdings input having been transmitted from the second computer system 204 to the first computer system 202 via the network 206 based on the holdings in the investor's portfolio. The holdings are determined by the current holdings of an investor, as represented in FIG. 3b.

The user of the second computer system 204 may manually input holdings by identifying the ticker associated with a particular holding, such as through drop down menu or free text search. Additionally, the user of the second computer system 204 may input holdings through file upload of the investor's holdings portfolio (e.g. excel or .csv file). Further, the user of the second computer system 202 may input holdings via application programming interface (API) call to a system having a record of the investor's holdings. For example, an API call utilizing a JSON web token to the Depository Trust Company (DTC) network may be used to input holdings to the first computer system 202. The holdings input is configured for causing the holdings to be stored by the first computer system 202.

In 107, processing the stored holdings by the first computer system 202 to determine the category corporate score and pillar corporate score for each holding. The first computer system 202 assigns a category corporate score and pillar corporate score to each holding. The category corporate score is determined by the data file provided from the fourth computer system 210 to the first computer system 202 that is stored in the first computer system 202, where the category corporate score is assigned to each category for each holding. The first computer system 202 then processes the pillar corporate score according to the algorithm of paragraph [0046]. The processing is further configured for storing the category corporate scores and pillar corporate scores for each holding.

When a holding does not have associated scores in the data file of the fourth computer system 210 (i.e. unscored holdings), the first computer system 202 processes the unscored holdings according to the user's predetermined treatment of unscored holdings. The user may predetermine treatment of unscored holdings according to one of the following treatments: (1) ignore the unscored holdings, where the first computer system removes the holding and its associated currency value from all calculations, including the match score, composite match score, and dollar weight; (2) apply the average corporate category scores based on similar holdings in the holdings class; or (3) apply the manually entered corporate category score based on a predetermined corporate category score.

In 108, transmitting a lens selection output to the second computer system 204 via the network 206 in response to the holdings input in 106. The lens selection output is configured to display a lens selection by the second computer system 204, as represented in FIG. 3c. The lens selection output is further configured for display by the second computer system 204, such as on the webpage through box selection, drop down menu, scrolling menu, or the like.

In 110, receiving a lens selection input, the lens selection input having been transmitted from the second computer system 204 to the first computer system 202 via the network 206 based upon the lens selection. The lens selection is determined by the investor's values as represented by the SEE categories. The lens selection input is configured for causing the selected lens to be stored by the first computer system 202.

The first computer system 202 may have one or more predetermined lenses for selection or a customized lens for selection. For example, predetermined lenses may include gender equity, faith, sustainability, ex-fossil fuels, or balanced. Predetermined lens selections have predetermined category ratings and pillar ratings. The customized lens selection provides the user's selection of category ratings and pillar ratings.

In 112, processing a lens selection input of 110. The processing is configured for assigning category ratings and pillar ratings as determined by the lens selection of 110. For example, the predetermined lens selections include the following category ratings and pillar ratings:
Balanced predetermined lens selection: all pillar ratings are rated very important; all category ratings are rated very important.
Gender equity: the environmental pillar is rated important, the SEE pillar is rated extremely important, the stakeholder engagement pillar is rated important; all categories in the environmental pillar are rated important, all categories in the SEE pillar are rated important, except for the gender equity category, which is rated extremely important, all categories in the stakeholder engagement pillar are rated important.
Faith: the environmental pillar is rated very important, the ethos pillar is rated very important, the stakeholder engagement pillar is rated important; all categories in the environmental pillar are rated extremely important, all categories in the ethos pillar are rated extremely important, all categories in the stakeholder engagement pillar are rated important.
Green/Ex-Fossil Fuel and Sustainability: the environmental pillar is rated extremely important, the ethos pillar is rated important, the stakeholder engagement pillar is rated important; all categories in the environmental pillar are rated extremely important, all categories in the ethos pillar are rated important, all categories in the stakeholder engagement pillar are rated important.
   In the event that a user selects more than one predetermined lens, the first computer system 202 assigns the highest rating per category, where the pillar weights and category weights are calculated as a customized lens.

The processing further includes determining pillar weights. The pillar weights are distributed between the pillars based on a total available percentage of 100% and calculated based on the pillar ratings. For a customized lens the pillar weights are calculated according to the pillar weighting algorithm of paragraph [0053]. For predetermined lenses, the system assigns the following pillar weights:
Balanced: each pillar has a pillar weight equal to 33.3%
Gender equity: the environmental pillar has a pillar weight equal to 28.56%; the ethos pillar has a pillar weight equal to 42.8%; the stakeholder engagement pillar has a weight equal to 28.56%
Faith: the environmental pillar has a pillar weight equal to 44.4%; the ethos pillar has a pillar weight equal to 44.4%; the stakeholder engagement pillar has a weight equal to 11.1%
Green/Ex-Fossil Fuel and Sustainability: the environmental pillar has a pillar weight equal to 66.6%; the ethos pillar has a pillar weight equal to 16.62%; the stakeholder engagement pillar has a weight equal to 16.62%

The processing further includes determining category weights. The category weights are processed according to the category weight algorithm of paragraph [0043]. The processing is configured for storing the category weights and pillar weights.

In 114, processing a match score by the first computer system 202. The processing of the match score includes the first computer system 202 processing the user-adjusted pillar corporate score and the user-adjust composite corporate score based upon the stored category corporate scores and stored pillar corporate scores from 107. When the ex-fossil fuel predetermined lens in selected in 110, the processing further includes identifying any holdings in the energy and utilities sectors (i.e. holdings with a GICS® industry categorization of energy and utilities), such that these holdings are flagged on the match score output.

The first computer system 202 then processes the user-adjusted pillar corporate score based on the category weights of 112 and the stored category corporate score of 107, according to the algorithm of paragraph [0047]. The first computer system 202 further processes the user-adjusted composite corporate score using the pillar weights of 112 and according to the algorithm [0048]. The processing is configured for having the user-adjusted pillar corporate score and the user-adjusted composite corporate score stored in the first computer system 202.

The processing then further includes determining the reflect scale for each holding. For example, the system may process the reflect scale for each holding according to the following scale:
Score (SEE value) from 0 to and including 2.25 yields a not aligned reflect scale
Score (SEE value) of 2.25 to and including 2.50 yields a somewhat aligned reflect scale
Score (SEE value) of 2.5 to and including 2.9 yields a mostly aligned reflect scale
Score (SEE value) of 2.9 to and including 4.0 yields a highly aligned reflect scale
   For each holding if the user-adjusted composite corporate score is in the top two core tiles of the reflect scale (e.g. greater than 2.5), then the currency value of the holding receives an aligned value, and if the reflect scale is in the bottom two quartiles then the currency value receives a not aligned value. The processing then includes determination of the match score by dividing the currency value of the “aligned” holdings by the total currency value of the holdings to determine in a percentage how aligned the portfolio is against the lens. The processing may further include determination of the match score of all scored holding by dividing the currency value of the “aligned” holding by the total currency value of the scored holdings to determine in a percentage how aligned the scored holdings in a portfolio are against the lens.

The match score may further include processing of the alignment of each pillar and category using the reflect scale and the user-adjusted pillar corporate score and the category corporate score to assign values of “not aligned,” “somewhat aligned,” “mostly aligned,” and “highly aligned” to each pillar and category, respectively. The processing is configured for storing the match score within the first computer system 202.

In 116, the match score output is transmitted by the first computer system 202 to the second computer system 204 via the network 206. The match score output is configured to display a match score by the second computer system 204, as represented in FIG. 3e. The match score output is further configured for display by the second computer system 204, such as on the webpage through graphical, pictorial, or textual language. The match score output may further be configured to display the dollar weight of the holdings by holding class or portfolio, as represented in FIG. 3l.

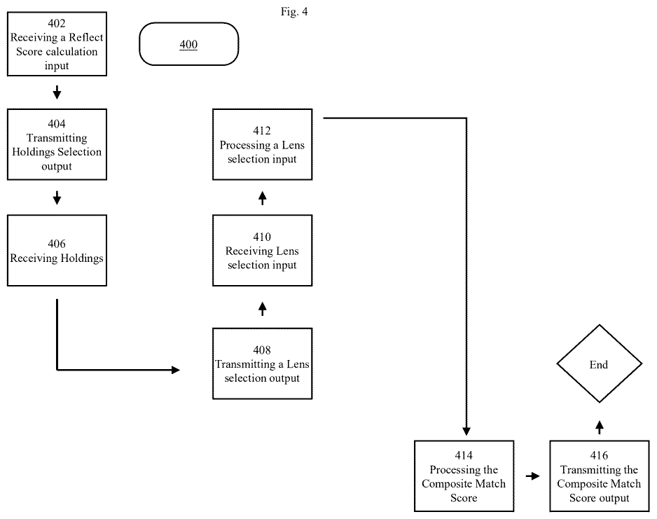

FIG. 4 is a flow chart representing a method of processing a composite match score. The method of processing the composite match score utilizes the system of FIG. 2. In 402, a first computer system 202, receives a match score calculation input, as described in 102 of FIG. 1.

In 404, based on the match score calculation input, transmitting a holdings selection output from the first computer system 202 to the second computer system 204 via the network 206, as described in 104 of FIG. 1.

In 406, receiving a holdings input, the holdings input having been transmitted from the second computer system 204 to the first computer system 202 via the network 206 based on the holdings in the investor's portfolio, as described in 106 of FIG. 1.

In 408, transmitting a lens selection output to the second computer system 204 via the network 206 based upon the holdings input in 406, as described in 108 of FIG. 1.

In 410, receiving a lens selection input, the lens selection input having been transmitted from the second computer system 204 to the first computer system 202 via the network 206 based upon the lens selection, as described in 110 of FIG. 1.

In 412, processing a lens selection input of 110, as described in 112 of FIG. 1.

In 414, processing a composite match score by the first computer system 202 to determine the dollar weighted alignment of the portfolio against the lens selection input of 110. The processing of the composite match score includes the first computer system 202 assigning a category corporate score and pillar corporate score to each holding, as described in 114 of FIG. 1. The processing further includes determining the user-adjusted pillar corporate score, based on the category weights of 412 and according to the algorithm of paragraph [0047], as described in 114 of FIG. 1. The processing further includes determining the user-adjusted composite corporate score, based on the pillar weights of 412 and according to the algorithm [0048].

The processing is further configured to dollar weight each holding within the portfolio. The dollar weight of the holding is processed by diving the dollar value of the holding within the total dollar value of the portfolio.

The processing further includes processing the composite match score of a holding class or the portfolio according to the following algorithm:

summation of(dollar weight per holding*user-adjusted composite corporate score of the holding)

The processing further includes converting the numerical value of the composite match score to a “not aligned,” “somewhat aligned,” “mostly aligned,” and “highly aligned” using a reflect scale, as described in 114 of FIG. 1.

The processing may further include determining the pillar composite match score of the holding class or portfolio per pillar according to the following algorithm:

summation of(dollar weight per holding*user-adjusted pillar corporate score of the holding).

Processing the pillar match score further includes converting the numerical value of the pillar match score to a “not aligned,” “somewhat aligned,” “mostly aligned,” and “highly aligned” using a reflect scale, as described in 114 of FIG. 1.

In 416, the composite match score output is transmitted by the first computer system 202 to the second computer system 204 via the network 206. The composite match score output is configured to display a composite match score by the second computer system 204. The composite match score output is further configured for display by the second computer system 204, such as on the webpage through graphical, pictorial, or textual language as represented in FIG. 3g.

The composite match score output may further be configured to display the pillar match scores by the second computer system 204 as represented in FIGS. 3e, 3h, 3i, and 3j. The composite match score output may further be configured to display the user-adjusted pillar corporate score as expressed by the reflect scale value as processed in 414, as represented by FIG. 3k.

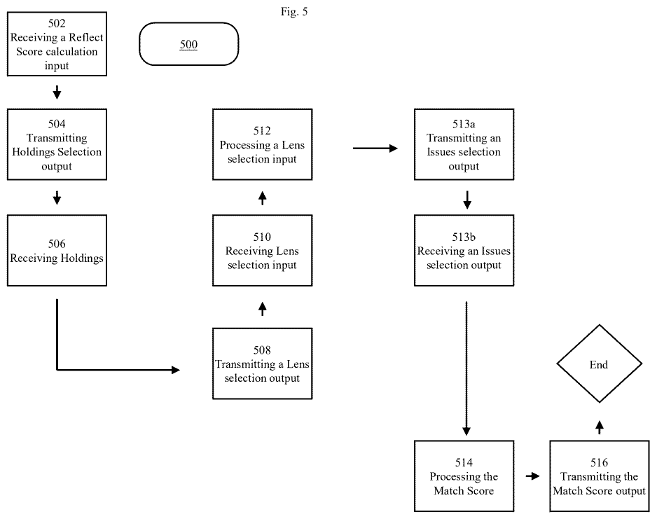

FIG. 5 is a flow chart representing a second method of processing a match score. The second method of processing the match score utilizes the system of FIG. 2. In 502, a first computer system 202, receives a match score calculation input, as described in 102 of FIG. 1.

In 504, based on the match score calculation input, transmitting a holdings selection output from the first computer system 202 to the second computer system 204 via the network 206, as described in 104 of FIG. 1.

In 506, receiving a holdings input, the holdings input having been transmitted from the second computer system 204 to the first computer system 202 via the network 206 based on the holdings in the investor's portfolio, as described in 106 of FIG. 1.

In 508, transmitting a lens selection output to the second computer system 204 via the network 206 based upon the holdings input in 506, as described in 108 of FIG. 1.

In 510, receiving a lens selection input, the lens selection input having been transmitted from the second computer system 204 to the first computer system 202 via the network 206 based upon the lens selection, as described in 110 of FIG. 1.

In 512, processing a lens selection input of 110, as described in 112 of FIG. 1.

In 513a, based on the processing of the lens selection input, transmitting an issues selection output from the first computer system 202 to the second computer system 204 via the network 206. The issues selection output is configured for causing the issues selections to be provided to the second computer system 204, as represented in FIG. 3f. The issues selection output includes issues that user's may consider contrary to their values, and where the user desires awareness as to whether their holdings include these issues. For example, issues may include alcohol, weapons, tobacco, gambling, pornography, animal testing, fossil fuels, and the like. The issues selection output is further configured to display issues selections, such as on a webpage via dropdown menu, check boxes, scrolling menu or the like.

In 513b, receiving an issues selection input from the second computer system 204 to the first computer system 202 via the network 206 based on the user's selection of issues. The issues are determined by the user, when the user desires to know if any of their holdings receive funds from, support, or otherwise utilize any of the practices identified as an issue. For example, a user may select the “animal testing” issue when the user desires to know whether any of its holdings include companies that utilize animal testing. The issues selection input is configured for causing the identified issues to be stored by the first computer system 202.

In 514, processing a match score by the first computer system 202 to determine the dollar weighted alignment of the portfolio against the lens selection input of 110, as described in 114 of FIG. 1. The processing of the match score further includes identifying any holdings that are associated with an issue on the stored issue selection input of 513a. The processing includes the first computer system 202 cross-referencing the holdings against the stored holdings—issues list to identify the issues associated with the holdings of the user's portfolio.

In 516, the match score output is transmitted by the first computer system 202 to the second computer system 204 via the network 206, as described in 116 of FIG. 1. The match score output is further configured to display an issues flag in the event any holdings include an issue on the store issue selection input of 513a. The issues flag identifies the holding and the associated issue, as represented in FIG. 3e. The match score output may further be configured to display a flagged holdings listing as represented by FIG. 3m, which identifies the holding and the associated issue present with the holding.

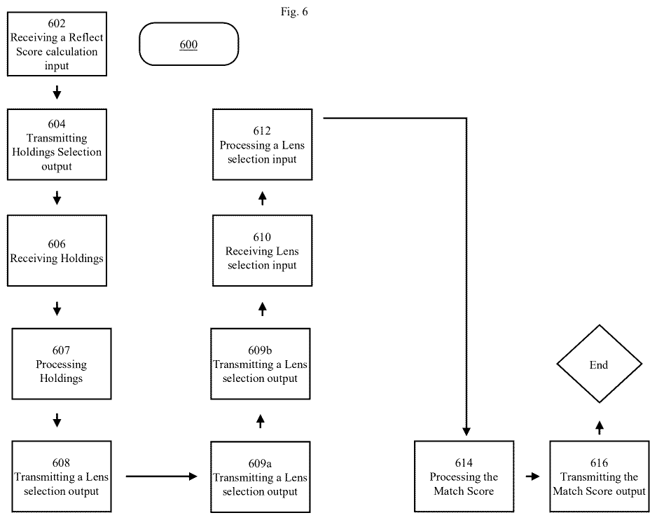

FIG. 6 is a flow chart representing a method of processing a match score that includes lens refinement. The method of processing the match score utilizes the system of FIG. 2. In 602, a first computer system 202, receives a match score calculation input, as described in 102 of FIG. 1.

In 604, based on the match score calculation input, transmitting a holdings selection output from the first computer system 202 to the second computer system 204 via the network 206, as described in 104 of FIG. 1.

In 606, receiving a holdings input, the holdings input having been transmitted from the second computer system 204 to the first computer system 202 via the network 206 based on the holdings in the investor's portfolio, as described in 106 of FIG. 1.

In 608, transmitting a lens selection output to the second computer system 204 via the network 206 based upon the holdings input in 406, as described in 108 of FIG. 1.

In 609a, receiving a lens selection input based on the predetermined lenses that is unrefined, the pre-refined lens selection input having been transmitted from the second computer system 204 to the first computer system 202 via the network 206 based upon the lens selection. The pre-refined lens selection is determined by the investor's values as represented by the SEE categories. The pre-fined lens selection input is configured for causing the selected lens to be stored by the first computer system 202.

In 609b, based upon the pre-refined lens selection input, transmitting a lens refinement selection output from the first computer system 202 to the second computer system 204 via the network 206. The lens refinement selection output is configured for causing the lens refinement selection to be provided to the second computer system 204. The lens refining selection output is further configured to display a lens refining selection by the second computer system 204, as represented in FIG. 3d. The lens refining selection display provides the user the ability to further customize category ratings to reflect their current values. For example, while a user's values may be primarily reflected through the predetermined lens of gender equity, the user may also rate the category of water use extremely important. In this example, the lens refining display allows a user to modify the predetermined rating of energy use to extremely important.

The lens refining selection display may also further provide the ability for the user to customize category ratings via pillar rating, where selecting a pillar rating modifies the category ratings to the selected pillar rating. For example, if a customized lens is selected, where all of the categories in the social pillar are rated as VI, the user may determine all of the categories in the social pillar EI and make this modification by selecting the pillar rating of very important.

In 610, receiving a lens selection input that is refined, the refined lens selection input having been transmitted from the second computer system 204 to the first computer system 202 via the network 206 based upon the refined lens selection, as described in 110 of FIG. 1.

In 412, processing a lens selection input of 610, as described in 112 of FIG. 1.

In 414, processing a match score as described in 114 of FIG. 1.

1. A method for quantitatively calculating alignment of an investor's non-financial values against a portfolio via a computer network, the method comprising:
receiving a reflect score calculation input at a first computer system, the reflect score calculation input having been transmitted via the computer network from a second computer system, the reflect score calculation input comprising a request to being calculation of a match score, the first computer system being associated with a service provider, the second computer system being associated with the investor;
transmitting a holdings selection output from the first computer system to the second computer system via the computer network, the holdings selection output configured for causing a holdings selection to be provided to the second computer system, wherein
providing the holdings selection includes causing a webpage having holdings selections to be displayed via a display of the second computer system, the webpage being associate with a website of the service provider;
receiving a holdings input at the first computer system, the holdings input having been transmitted from the second computer system to the first computer system via the computer network, the holdings input comprising holdings of the portfolio and configured for storing the holdings by the first computer system;
processing category corporate scores, the processing configured to assign the category corporate scores to the holdings and to store the category corporate scores in association with the holdings, respectively;
transmitting a lens selection output to the second computer system via the computer network, the lens selection output configured for causing a lens selection to be provided to the second computer system, wherein
providing the lens selection includes causing the webpage having lens selections to be displayed via the display of the second computer system;
receiving a lens selection input at the first computer system, the lens selection input having been transmitted from the second computer system to the first computer system via the computer network, the lens selection input comprising the investor's non-financial values and configured for storing the lens selection by the first computer system;
based upon the lens selection input, processing the lens selection input, the lens selection input being processed by the first computer system, the processing of the lens selection input configured to assign category ratings and category numerical ratings in association with the categories, respectively, for determination of a weighting variable, wherein the weighting variable is determined by a weighting variable algorithm of
100/((Numerical rating of EI*Number of assigned EI category ratings)+(Numerical rating of VI*Number of assigned VI category ratings)+(Numerical rating of I*Number of assigned I category ratings)
based upon the weighting variable, processing category weights for determination of a match score, the processing of the category weights configured to assign category weights, wherein the category weights are determined by multiplying the category numerical rating and the weighting variable and configured to store the category weights;
based upon the stored category corporate score and category weights, processing a user-adjusted composite corporate score for each holding, the processing of the user-adjusted composite corporate score for each holding configured for assigning each holding its user-adjusted composite corporate score and for storing each user-adjusted composite corporate score in association with the holding, respectively;
based upon the user-adjusted composite corporate score, processing the match score, the processing of the match score configured to assign a reflect scale to each holding, wherein the match score is the percentage of currency of the holdings having an aligned reflect scale out of the currency of the portfolio and configured for storing the match score;
based upon the stored match score, transmitting a match score output to the second computer system via the computer network, the match score output configured for causing the stored match score to be provided to the second computer system, wherein
providing the stored match score includes causing the webpage having the stored match score to be displayed via the display of the second computer system.

2. The method of claim 1, further comprising
based upon the lens selection output, receiving a pre-refined lens selection input at the first computer system, the pre-refined lens selection input having been transmitted from the second computer system to the first computer system via the computer network, the pre-refined lens selection input comprising the predetermined lens selection and configured for storing the predetermined lens selection by the first computer system;
based upon the pre-refined lens selection input, transmitting a lens refinement selection output from the first computer system to the second computer system via the computer network, the lens refinement selection output configured for causing the lens refinement to be provided to the second computer system, wherein
providing the lens refinement selection includes causing a webpage having categories displayed in association with modifiable ratings to be displayed via a display of the second computer system;
and wherein the lens selection input further comprises the refined lens selection.

3. The method of claim 1, further comprising
transmitting an issues selection output from the first computer system to the second computer system via the computer network, the issues selection output configured for causing the issues selection to be provided to the second computer system, wherein
providing the issues selection includes causing a webpage having issues displayed for selection via a display of the second computer system;
receiving an issues selection input at the first computer system, the issues selection input having been transmitted from the second computer system via the computer network, the issues selection input comprising issues and configured for storing the issues by the first computer system, wherein
processing the match score further comprises identifying holdings that are associated with the stored issues, and wherein
the match score output is further configured to display the identified holdings and the corresponding stored issues.

4. A method for quantitatively calculating alignment of an investor's non-financial values against a portfolio via a computer network, the method comprising:
receiving a reflect score calculation input at a first computer system, the reflect score calculation input having been transmitted via the computer network from a second computer system, the reflect score calculation input comprising a request to being calculation of a match score, the first computer system being associated with a service provider, the second computer system being associated with the investor;
transmitting a holdings selection output from the first computer system to the second computer system via the computer network, the holdings selection output configured for causing a holdings selection to be provided to the second computer system, wherein
providing the holdings selection includes causing a webpage having holdings selections to be displayed via a display of the second computer system, the webpage being associate with a website of the service provider;
receiving a holdings input at the first computer system, the holdings input having been transmitted from the second computer system to the first computer system via the computer network, the holdings input comprising holdings of the portfolio and configured for storing the holdings by the first computer system;
processing category corporate scores, the processing configured to assign category corporate scores to the holdings and to store the category corporate scores in association with the holdings, respectively;
transmitting a lens selection output to the second computer system via the computer network, the lens selection output configured for causing a lens selection to be provided to the second computer system, wherein
providing the lens selection includes causing the webpage having lens selections to be displayed via the display of the second computer system;
receiving a lens selection input at the first computer system, the lens selection input having been transmitted from the second computer system to the first computer system via the computer network, the lens selection input comprising the investor's non-financial values and configured for storing the lens selection by the first computer system;
based upon the lens selection input, processing the lens selection input, the lens selection input being processed by the first computer system, the processing of the lens selection input configured to assign category ratings and category numerical ratings in association with the categories, respectively, for determination of a weighting variable, wherein the weighting variable is determined by a weighting variable algorithm of
100/((Numerical rating of EI*Number of assigned EI category ratings)+(Numerical rating of VI*Number of assigned VI category ratings)+(Numerical rating of I*Number of assigned I category ratings)
based upon the weighting variable, processing category weights for determination of a composite match score, the processing of the category weights configured to assign category weights, wherein the category weights are determined by multiplying the category numerical rating and the weighting variable and configured to store the category weights;
based upon the stored category corporate score and category weights, processing a user-adjusted composite corporate score for each holding, the processing of the user-adjusted composite corporate score for each holding configured for assigning each holding its user-adjusted composite corporate score and for storing each user-adjusted composite corporate score in association with the holding, respectively;
based upon the user-adjusted composite corporate score, processing a composite match score, the processing of the composite match score configured to assign a reflect scale to the portfolio, wherein the composite match score is the summation of the product of a dollar weight of the holding multiplied by the user-adjusted composite corporate score of the holding and configured to store the composite match score;
based upon the stored composite match score, transmitting a composite match score output to the second computer system via the computer network, the composite match score output configured for causing the stored composite match score to be provided to the second computer system, wherein
providing the stored composite match score includes causing the webpage having the stored composite match score to be displayed via the display of the second computer system.

5. The method of claim 4, further comprising
based upon the lens selection output, receiving a pre-refined lens selection input at the first computer system, the pre-refined lens selection input having been transmitted from the second computer system to the first computer system via the computer network, the pre-refined lens selection input comprising a predetermined lens selection and configured for storing the predetermined lens selection by the first computer system;
based upon the pre-refined lens selection input, transmitting a lens refinement selection output from the first computer system to the second computer system via the computer network, the lens refinement selection output configured for causing a lens refinement to be provided to the second computer system, wherein
providing the lens refinement selection includes causing a webpage having categories displayed in association with modifiable ratings to be displayed via a display of the second computer system;
and wherein the lens selection input further comprises a refined lens selection.

6. The method of claim 4 further comprising:
transmitting an issues selection output from the first computer system to the second computer system via the computer network, the issues selection output configured for causing an issues selection to be provided to the second computer system, wherein
providing the issues selection includes causing a webpage having issues displayed for selection via a display of the second computer system;
receiving an issues selection input at the first computer system, the issues selection input having been transmitted from the second computer system via the computer network, the issues selection input comprising issues and configured for storing the issues by the first computer system, wherein
processing the match score further comprises identifying holdings that are associated with the stored issues, and wherein
the composite match score output is further configured to display the identified holdings and the corresponding stored issues.

7. The method of claim 4 wherein
the composite match score output is further configured to display the dollar weight of the holdings by holding class.

8. The method of claim 4 wherein
the composite match score output is further configured to display the dollar weight of the holdings by the portfolio.

9. The method of claim 4, wherein
the composite match score output is further configured to display the composite match score for each reflect scale value per pillar.

10. A method for quantitatively calculating the alignment of an investor's non-financial values against a portfolio via a computer network, the method comprising:
receiving a reflect score calculation input at a first computer system, the reflect score calculation input having been transmitted via the computer network from a second computer system, the reflect score calculation input comprising a request to being calculation of a match score, the first computer system being associated with a service provider, the second computer system being associated with the investor;
transmitting a holdings selection output from the first computer system to the second computer system via the computer network, the holdings selection output configured for causing a holdings selection to be provided to the second computer system, wherein
providing the holdings selection includes causing a webpage having holdings selections to be displayed via a display of the second computer system, the webpage being associate with a website of the service provider;
receiving a holdings input at the first computer system, the holdings input having been transmitted from the second computer system to the first computer system via the computer network, the holdings input comprising holdings of the portfolio and configured for storing the holdings by the first computer system;
processing category corporate scores and pillar corporate scores, the processing configured to assign the category corporate scores and the pillar corporate scores to the holdings and to store the category corporate scores and the pillar corporate scores in association with the holdings, respectively;
transmitting a lens selection output to the second computer system via the computer network, the lens selection output configured for causing a lens selection to be provided to the second computer system, wherein
providing the lens selection includes causing the webpage having lens selections to be displayed via the display of the second computer system;
receiving a lens selection input at the first computer system, the lens selection input having been transmitted from the second computer system to the first computer system via the computer network, the lens selection input comprising the investor's non-financial values and configured for storing the lens selection by the first computer system;
based upon the lens selection input, processing the lens selection input, the lens selection input being processed by the first computer system, the processing of the lens selection input configured to assign category ratings and category numerical ratings in association with the categories, respectively, for determination of a weighting variable, wherein the weighting variable is determined by a weighting variable algorithm of
100/((Numerical rating of EI*Number of assigned EI category ratings)+(Numerical rating of VI*Number of assigned VI category ratings)+(Numerical rating of I*Number of assigned I category ratings)
based upon the weighting variable processing category weights for determination of a pillar match score, the processing of the category weights configured to assign category weights, wherein the category weights are determined by multiplying the category numerical rating and the weighting variable and configured to store the category weights;
based upon the stored category corporate score and category weights, processing user-adjusted pillar corporate score for each holding, the processing of the user-adjusted pillar corporate score for each holding configured for assigning each holding its user-adjusted pillar corporate score and for storing each user-adjusted pillar corporate score in association with the holding, respectively;
based upon the user-adjusted pillar corporate score, processing the pillar match scores, the processing of the pillar match score configured to assign a reflect scale to each pillar, wherein the pillar match score is a summation of the product of a dollar weight of the holding multiplied by the user-adjusted pillar corporate score of the holding and configured to store the pillar match scores;
based upon the stored pillar match scores, transmitting a pillar match score output to the second computer system via the computer network, the pillar match score output configured for causing the stored pillar match scores to be provided to the second computer system, wherein
providing the stored pillar match scores includes causing the webpage having the stored pillar match scores to be displayed via the display of the second computer system.

11. The method of claim 10, further comprising:
based upon the lens selection output, receiving a pre-refined lens selection input at the first computer system, the pre-refined lens selection input having been transmitted from the second computer system to the first computer system via the computer network, the pre-refined lens selection input comprising the predetermined lens selection and configured for storing the predetermined lens selection by the first computer system;
based upon the pre-refined lens selection input, transmitting a lens refinement selection output from the first computer system to the second computer system via the computer network, the lens refinement selection output configured for causing a lens refinement to be provided to the second computer system, wherein
providing the lens refinement selection includes causing a webpage having categories displayed in association with modifiable ratings to be displayed via a display of the second computer system;
and wherein the lens selection input further comprises a refined lens selection.

12. The method of claim 10, further comprising:
transmitting an issues selection output from the first computer system to the second computer system via the computer network, the issues selection output configured for causing an issues selection to be provided to the second computer system, wherein
providing the issues selection includes causing a webpage having issues displayed for selection via a display of the second computer system;
receiving an issues selection input at the first computer system, the issues selection input having been transmitted from the second computer system via the computer network, the issues selection input comprising issues and configured for storing the issues by the first computer system, wherein
processing the pillar match score further comprises identifying holdings that are associated with the stored issues, and wherein
the pillar match score output is further configured to display the identified holdings and the corresponding stored issues.

13. The method of claim 10 wherein:
the pillar match score output is further configured to display the dollar weight of the holdings by holding class.

14. The method of claim 10, wherein
the pillar match score output is further configured to display the dollar weight of the holdings by the portfolio.

15. The method of claim 10, wherein
the pillar match score output is further configured to display the user-adjusted pillar corporate score per pillar as expressed by the reflect scale.

16. The method of claim 10, wherein
the pillar match score output is further configured to display the pillar match score for each reflect scale value per pillar.
